(19) United States
(12) Patent Application Publication
(10) Pub. No.: US 2017/0177810 A1
(43) Pub. Date: Jun. 22, 2017

(54) SYSTEM AND METHOD FOR INSURANCE RISK ADJUSTMENT

(71) Applicant: Availity, LLC, Jacksonville, FL (US)

(72) Inventors: Joy L. Fulton, Jacksonville, FL (US); Trent J. Gavazzi, Ponte Vedra Beach, FL (US)

(21) Appl. No.: 15/382,266

(22) Filed: Dec. 16, 2016

Related U.S. Application Data
(60) Provisional application No. 62/268,253, filed on Dec. 16, 2015.

(51) Int. Cl. G06F 19/00

(52) U.S. Cl. CPC G06F 19/328; G06F 19/345

(57) ABSTRACT

Technologies for identifying coding/care gaps of an insurance claim include a computing device configured to receive an insurance claim from a healthcare provider, create a claim encounter reconciliation data pack (CERDP) based on the received insurance claim, and analyze the CERDP to identify whether any coding/care gaps exist in the received insurance claim. Upon determining any coding/care gaps, the computing device is additionally configured to provide an interface to the healthcare provider usable to view and resolve the identified coding/care gaps. The computing device is further configured to receive updated claim information as a function of the resolution of the identified coding/care gaps and transmit a related insurance claim to a corresponding health plan. Other embodiments are described herein.

### CROSS-REFERENCE TO RELATED APPLICATIONS

The present application is a non-provisional of, and claims priority to U.S. Provisional Patent Application Ser. No. 62/268,253, filed Dec. 16, 2015, and titled “System and Method for Insurance Risk Adjustment”, which is herein incorporated by reference in its entirety.

### TECHNICAL FIELD OF THE DISCLOSED EMBODIMENTS

The disclosed embodiments relate generally to insurance risk adjustment and, more particularly, to a system and method for insurance risk adjustment.

### BACKGROUND OF THE DISCLOSED EMBODIMENTS

Insurance market reforms under the Affordable Care Act were designed to increase the number of Americans with insurance and change the traditional system in which insurance carriers have been incentivized to enroll healthy people, as opposed to less than healthy people. One of the arrangements of the new system is the incorporation of risk adjustment, a process by which health insurance plans are compensated based on the underlying health status of the people they enroll, and are therefore ideally protected from losing money by covering people with high-cost conditions.

Often times, collecting, organizing, and analyzing medical records can be difficult. Typically, records have to be obtained from multiple sources, which is complicated by the fact that a lot of older medical records are still in hardcopy form. While the insurance carrier record requests for risk-based businesses are not subject to a fee because the medical service provider is subject to the contract terms of the insurance organization and the insurance plans the provider accepts, insurance carriers recognize that the responsiveness of their provider organizations will increase if an incentive fee is administered for the additional administrative burden associated with record retrieval and the corrective coding process. In some instances, the incentive fee may be a flat fee plus additional processing expenses. Incentive payments for records can be significant, depending on the size of the record requested or any vendor fees associated with outsourcing the process on both the healthcare providers' and insurance carriers' behalf.

Various insurance carrier hurdles for medical record data collection include relationships between providers, processing turnaround times, copying fees, paper medical records, increasing Health Insurance Portability and Accountability Act (HIPAA) compliance, and the like. Additionally, providers can be resistant to medical record data collection as a result of the sheer volume of data and the manual entry of such data, as well as incorrect medical record retrieval lists, having to accommodate unknown, third parties, an inability to lock down electronic medical records systems, HIPAA concerns, etc.

Traditionally, Medicare Advantage plans have been the most prominent plans utilizing a risk adjustment payment methodology that required the additional document and coding corrections. However, insurance market reforms under the Affordable Care Act extend the usability of risk adjustment. For example, risk adjustment will be required of all qualified health insurance plans sold to individuals and small groups both within and outside of the health insurance exchanges.

Much of the practical knowledge surrounding the implementation of risk adjustment comes from experience with the Medicare program. For example, about one in four Medicare beneficiaries purchase a Medicare Advantage plan, which is a private health insurance plan that offers Medicare benefits. Payments to such private plans have traditionally been adjudicated to reflect differences in the health risks of their enrollees, initially by adjudicating payments by demographic characteristics, including age, sex, and Medicaid eligibility. Since 2000, risk adjudicated payments to Medicare Advantage plans have additionally used data on patient diagnoses obtained from hospital admissions. Medicare's risk adjustment techniques have also been refined by incorporating diagnostic information from beneficiaries' use of outpatient care and prescription drugs. Risk adjustment is also being used by many state Medicaid programs, as well.

In risk adjustment, a third party, such as the federal government or a state, collects and organizes data from insurance claims and clinical diagnoses for all enrollees in every participating insurance carrier or provider organization in a particular market. Using a risk assessment tool or methodology, this entity then converts the data into a risk score for each person. Individual risk scores are then aggregated into an overall score for each insurance plan. If the average risk score for the overall population is defined as 1.0, a healthy young man might receive a score of 0.4 based on historical claims data, while a young woman with asthma might be scored at 1.5, and an elderly person with diabetes might be scored at 2.3. In an illustrative example, a plan having an aggregate score of 1.2 for its enrollees would receive a 20 percent add-on to its average per person payments, while a plan with an aggregate score of 0.8 would experience a 20 percent reduction in payments.

In practice, individual risk scores, built from data on patient demographics, disability, institutional status, and diagnoses, are used to help determine monthly payments made to plans for each person enrolled in Medicare Advantage, Medicare Part D prescription drug benefits, and many state Medicaid managed care programs. The private health insurance market, prior to passage of the Affordable Care Act, was organized very differently. Overall, insurers operating in the individual or small-group insurance markets had an incentive to enroll healthy, younger people, and a corresponding disincentive to enroll older, less healthy people. These factors contributed to rising levels of uninsured people. These factors may also have resulted in higher premiums in the private insurance market, as health care providers raised their charges to private payers to help cover the costs of uncompensated care.

Traditionally, private health insurers operating in the individual and small-group markets based their premiums on health history, or what was known as “experience rating.” A person with diabetes or a heart condition would be charged a higher premium than one whose health records showed only trouble-free annual checkups. Likewise, a small company with above-average care needs and costs paid more to cover its employees than it would pay if its employees were healthier. In addition, insurers selling individual health insurance policies were able to deny coverage to people because of past or current health conditions. The Department of Health and Human Services (HHS) estimated that without the Affordable Care Act, up to 129 million nonelderly Americans with preexisting conditions would be at risk of losing their insurance coverage when they needed it most or might not be able to purchase affordable individual insurance coverage.

However, as noted above, insurance reforms contained in the Affordable Care Act made major changes to the insurance market and insurance regulation. For example, as of Sep. 23, 2010, insurance carriers were barred from excluding children from insurance coverage because of preexisting health conditions. In another example, as of Jan. 1, 2014, plans were also barred from using preexisting condition restrictions to prevent adults from receiving coverage. Plans are also no longer allowed to charge premiums based on health history. After 2014, however, insurance carriers are still be able to vary premium levels for individuals and small businesses based on certain factors, including age, family size, geographic region, and tobacco use. The law allows no more than a 3:1 difference in price across age groups, meaning that older people can be charged three times as much as younger people, and no more than a 1.5:1 difference in price for individuals who use tobacco, meaning they can be charged up to 50 percent more than nonusers.

In conjunction with these new insurance rules, the Affordable Care Act requires the creation of health insurance exchanges in each state. Through the exchanges, individuals and companies with no more than 100 employees are able to shop for health insurance policies, known as “qualified health plans,” that offer a package of “essential health benefits” and meet other standards. States have the option of establishing and operating exchanges on their own or having the federal government run one for them. Because the exchanges will feature standardized benefit options and restrict insurers' ability to base premiums on their enrollees' health status, plans that enroll a sicker-than-average enrollee population will be in danger of losing money, while plans that enroll relatively healthier enrollees will probably be overpaid. Ultimately, if too many plans lose money, some could go out of business, and the overall system could be seriously destabilized.

To prevent this from happening, the law requires the use of risk adjustment to reallocate premium income among plans to account for differences in their enrollees' aggregate health conditions, and therefore the likely cost of paying for their care. Risk adjustment methods similar to those used in Medicare Advantage or the Medicare Part D prescription drug benefit are used, or states can propose an alternative methodology subject to approval by HHS. If a state does not establish a system of risk adjustment, HHS establishes and operates one for that state. Risk adjustment is required of all qualified health insurance plans sold to individuals and small groups both within and outside of the exchanges. “Grandfathered” health insurance plans—those in existence at the time the Affordable Care Act was signed into law—are exempt from risk adjustment as well as many other provisions of the health care reform law. However, it is widely anticipated that many of these plans will disappear over time.

Generally, medical care is delivered to the insured plan member by the medical provider. The diagnoses made by the medical provider and the care delivered to the member are documented in the patient's medical record (chart). Staff in the medical provider's office are typically tasked with submitting insurance plan claims based upon the diagnoses and care documented in the medical record. Prior to Oct. 1, 2015, the International Classification of Diseases, Ninth Revision, Clinical Modification (ICD-9-CM) was based on the World Health Organization's Ninth Revision, International Classification of Diseases (ICD-9). ICD-9-CM was the official system of assigning codes to diagnoses and procedures associated with medical provider utilization in the United States.

As of Oct. 1, 2015, ICD-10-CM was the replacement for ICD-9-CM, volumes 1 and 2. The provider's staff determine the appropriate ICD-10-CM code or codes to reference in the insurance claim based upon the contents of the member's medical record. This claim is then submitted to the health plan. The code or codes are submitted to the Centers for Medicare and Medicaid (CMS), which converts submitted code or codes to Hierarchical Condition Categories (HCC) codes, which are used in a Risk Adjustment Model that measures the disease burden of the health plan's insured population over a 12 month period. Based upon this risk adjustment calculation, capitation payments to private health care plans for the health expenditure risk of their enrollees may be adjusted.

In order for a claim to be HIPAA compliant and to be adjudicated properly within the health plan, only one diagnosis code is required. While a patient's care may be robustly documented in the medical record, there is no guarantee that the provider's office staff will capture this information in the form of all relevant diagnosis codes being placed on the insurance claim submitted to the health plan. Given that the staff member is focused on submitting (and possibly incented to submit) as many claims as possible during the given day, robust data entry in a “per claim” context is not the focus of their role. This is the onset of the inaccurate data capture process.

### SUMMARY OF THE DISCLOSED EMBODIMENTS

In one aspect, a method for coding/care gap identification. The method includes receiving, by a computing device, an insurance claim from a healthcare provider; creating, by the computing device, a claim encounter reconciliation data pack (CERDP) based on the received insurance claim; analyzing, by the computing device, the CERDP to identify whether any coding/care gaps exist in the received insurance claim; providing, by the computing device and in response to having determined one or more coding/care gaps as a function of the analysis of the CERDP, the healthcare provider with an interface to view and resolve the identified coding/care gaps; receiving, by the computing device via the interface, related claim information as a function of the resolution of the identified coding/care gaps; generating, by the computing device and in response to a determination that the identified coding/care gaps have been resolved, an encounter claim, wherein the encounter claim includes the related claim information and at least a portion of the information of the CERDP; and transmitting, by the computing device, the generated encounter claim to a corresponding health plan.

In some embodiments, analyzing the CERDP comprises comparing the claim information of the CERDP to corresponding patient information of a gap table, wherein the corresponding patient information of the gap table includes patient demographic information, historical claim information, historical treatment information, previously submitted diagnosis codes, and health plan information. In other embodiments, creating the CERDP comprises (i) processing the received claim, (ii) extracting data from the received claim as a function of the processing of the received claim, (iii) generating the CERDP, and (iv) incorporating the extracted data into the generated CERDP. Additionally, in some embodiments, extracting data from the received claim comprises extracting at least one of patient demographic information, treatment information, and one or more diagnosis codes.

In some embodiments, submitting, by the computing device, the received insurance claim to a corresponding health plan, wherein the insurance claim is usable to adjudicate the insurance claim. In other embodiments, updating, by the computing device and in response to having received the updated claim information as a function of the resolution of the identified coding/care gaps, the gap table based on the updated claim information. In still other embodiments, providing, by the computing device and in response to having determined the one or more coding/care gaps, the healthcare provider with an indication of the identified coding/care gaps via a notification viewable in the provided interface.

In another aspect, a computing device for coding/care gap identification includes one or more computer-readable medium comprising instructions; one or more processors coupled with the one or more computer-readable medium and configured to execute the instructions to: receive an insurance claim from a healthcare provider; create a claim encounter reconciliation data pack (CERDP) based on the received insurance claim; analyze the CERDP to identify whether any coding/care gaps exist in the received insurance claim; provide, in response to having determined one or more coding/care gaps as a function of the analysis of the CERDP, the healthcare provider with an interface to view and resolve the identified coding/care gaps; receive, via the interface, related claim information as a function of the resolution of the identified coding/care gaps; generate, in response to a determination that the identified coding/care gaps have been resolved, an encounter claim, wherein the encounter claim includes the related claim information and at least a portion of the information of the CERDP; and transmit the generated encounter claim to a corresponding health plan.

In some embodiments, to analyze the CERDP comprises to compare the claim information of the CERDP to corresponding patient information of a gap table, wherein the corresponding patient information of the gap table includes patient demographic information, historical claim information, historical treatment information, previously submitted diagnosis codes, and health plan information. In other embodiments, to create the CERDP comprises to (i) process the received claim, (ii) extract data from the received claim as a function of the processing of the received claim, (iii) generate the CERDP, and (iv) incorporating the extracted data into the generated CERDP. Additionally, in some embodiments, to extract data from the received claim comprises to extract at least one of patient demographic information, treatment information, and one or more diagnosis codes.

In some embodiments, the one or more computer-readable medium are further configured to execute the instructions to submit the received insurance claim to a corresponding health plan, wherein the insurance claim is usable to adjudicate the insurance claim. In other embodiments, the one or more computer-readable medium are further configured to execute the instructions to update, in response to having received the updated claim information as a function of the resolution of the identified coding/care gaps, the gap table based on the updated claim information. In still other embodiments, the one or more computer-readable medium are further configured to execute the instructions to provide, in response to having determined the one or more coding/care gaps, the healthcare provider with an indication of the identified coding/care gaps via a notification viewable in the provided interface.

In yet another aspect, a non-transitory computer-readable medium storing executable instructions on a computing device, the executable instructions that cause the computing device to perform the steps of: receive an insurance claim from a healthcare provider; create a claim encounter reconciliation data pack (CERDP) based on the received insurance claim; analyze the CERDP to identify whether any coding/care gaps exist in the received insurance claim; provide, in response to having determined one or more coding/care gaps as a function of the analysis of the CERDP, the healthcare provider with an interface to view and resolve the identified coding/care gaps; receive, via the interface, related claim information as a function of the resolution of the identified coding/care gaps; generate, in response to a determination that the identified coding/care gaps have been resolved, an encounter claim, wherein the encounter claim includes the related claim information and at least a portion of the information of the CERDP; and transmit the generated encounter claim to a corresponding health plan.

In some embodiments, to analyze the CERDP comprises to compare the claim information of the CERDP to corresponding patient information of a gap table, wherein the corresponding patient information of the gap table includes patient demographic information, historical claim information, historical treatment information, previously submitted diagnosis codes, and health plan information. In other embodiments, to create the CERDP comprises to (i) process the received claim, (ii) extract data from the received claim as a function of the processing of the received claim, (iii) generate the CERDP, and (iv) incorporating the extracted data into the generated CERDP. Additionally, in some embodiments, to extract data from the received claim comprises to extract at least one of patient demographic information, treatment information, and one or more diagnosis codes.

In some embodiments, the executable instructions further cause the computing device to execute the instructions to submit the received insurance claim to a corresponding health plan, wherein the insurance claim is usable to adjudicate the insurance claim. In other embodiments, the executable instructions further cause the computing device to execute the instructions to update, in response to having received the updated claim information as a function of the resolution of the identified coding/care gaps, the gap table based on the updated claim information. In still other embodiments, the executable instructions further cause the computing device to execute the instructions to provide, in response to having determined the one or more coding/care gaps, the healthcare provider with an indication of the identified coding/care gaps via a notification viewable in the provided interface.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a block diagram of an illustrative system for coding/care gap identification and resolution that includes one or more computing devices of a healthcare provider and a health plan communicatively coupled to one or more computing devices of a coding/care gap identifier;

FIG. 2 is a block diagram of an illustrative embodiment of one of the computing devices of the system of FIG. 1;

FIG. 3 is a block diagram of an illustrative embodiment of an environment of an coding/care gap analysis engine capable of being embedded on the one or more computing devices of the coding/care gap identifier of the system of FIG. 1;

FIGS. 4A and 4B are a schematic flow diagram of an illustrative method for coding/care gap identification that may be performed by the coding/care gap analysis engine of FIG. 3; and

FIG. 5 is a schematic flow diagram of an illustrative method for resolving identified insurance gaps that may be performed by the coding/care gap analysis engine of FIG. 3.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

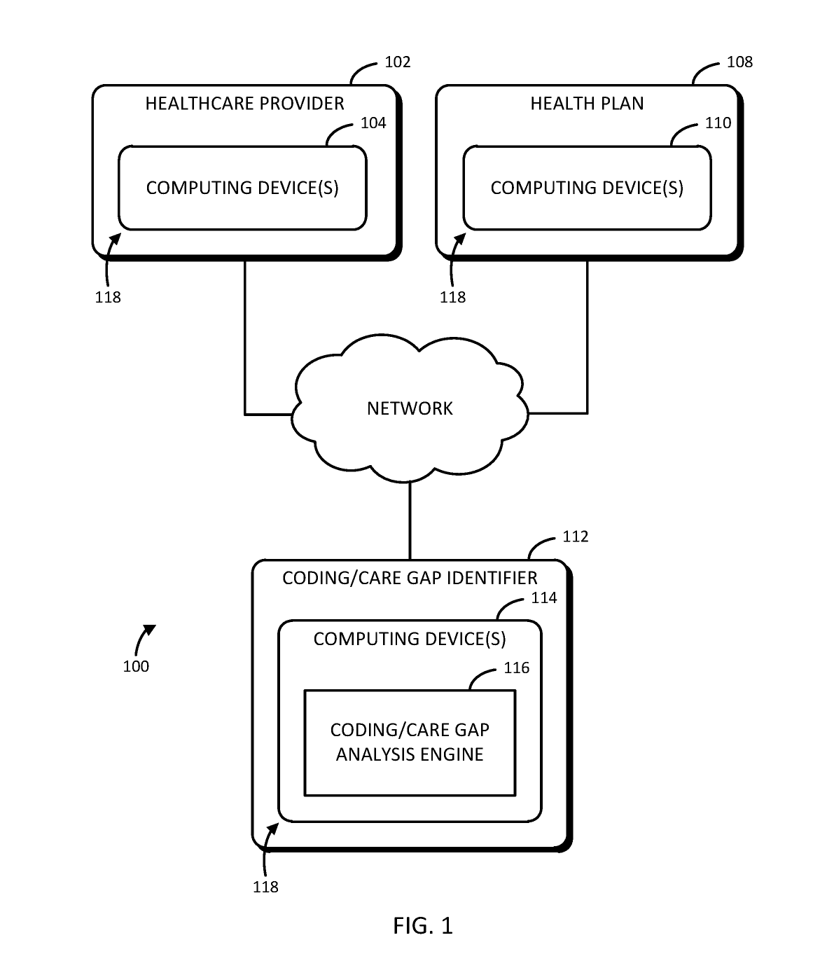

FIG. 1 illustrates a system 100 for capturing and confirming coding/care gap data that includes a healthcare provider 102, a health plan 108, and an coding/care gap identifier 112, each of which include one or more computing devices 118 communicatively coupled via a network 106. In particular, the system 100 is configured to identify gaps in insurance claims (e.g., coding/care gaps) and facilitate the resolution of any identified coding/care gaps in the insurance claims. To do so, as will be described in further detail below, the healthcare provider 102 transfers (i.e., via one or more of the healthcare provider computing devices 104) an insurance claim to the coding/care gap identifier 112 (i.e., received at one or more of the coding/care gap identifier computing device(s) 114).

Upon receipt of the insurance claim, the coding/care gap identifier 112 (e.g., via the coding/care gap analysis engine 116, described in detail below) utilizes logic to generate a claim encounter reconciliation data pack (CERDP) and analyzes the CERDP to identify any coding/care gaps. If any coding/care gaps are identified, the coding/care gap identifier 112 notifies the healthcare provider 102 of the detected coding/care gap(s) (i.e., via one or more of the healthcare provider computing devices 104). Accordingly, the coding/care gaps can be resolved by the healthcare provider 102, at which point the coding/care gap analysis engine 116 may create an encounter claim related to the original insurance claim submitted by the healthcare provider 102 to the health plan 108 (i.e., at one or more of the health plan computing devices 110). It should be appreciated that in the event no gaps were detected, no related encounter claim is created by the coding/care gap analysis engine 116.

The healthcare provider 102 may include any type of health professional or healthcare provider/practitioner who performs preventative, curative, promotional, or rehabilitative health care services, such as physicians, nurses, doctors, pharmacists, therapists, and the like. Accordingly, in some embodiments, the healthcare provider 102 may include a single health professional (e.g., a solo practitioner) or multiple health professionals (e.g., a hospital that employs more than one health professional). Irrespective of the number of health professionals, it should be appreciated that the healthcare provider 102, as described herein, is capable of providing health care services and generating an insurance claim for payment (e.g., by the patient and/or the health plan 108) in exchange for the rendered health care services.

Additionally, the healthcare provider 102 is configured to exchange information (e.g., insurance claim information) between the coding/care gap identifier 112, by way of the one or more computing devices 118 of the healthcare provider 102 (i.e., the healthcare provider computing device(s) 104) and the one or more computing devices 118 of the coding/care gap identifier 112 (i.e., the coding/care gap identifier computing device(s) 114). As such, the healthcare provider computing device(s) 104 may include one or more endpoint computing devices (e.g., mobile computing devices, desktop computers, etc.) capable of interfacing with the coding/care gap identifier computing device(s) 114 via one or more access points, routers, switches, servers, compute devices, storage devices, etc., which may be in addition to those network computing devices of the network 106 as described herein.

The health plan 108 may include any type of entity which provides potential patients of the healthcare provider 102 with a managed care plan, or health insurance plan, such as may be provided via a contract between healthcare providers 102 and the health plan 108 to provide medical care. The healthcare providers 102 form a health plan's provider network, which typically has rules associated therewith that stipulated the costs associated with health care services and how much (i.e., of the total cost) the health plan 108 will pay for the health care services rendered by the network of the healthcare providers 102.

Similar to the healthcare provider 102, the health plan 108 is additionally configured to exchange information (e.g., insurance claim information) between the coding/care gap identifier 112, by way of the one or more computing devices 118 of the health plan 108 (i.e., the health plan computing device(s) 110) and the one or more computing devices 118 of the coding/care gap identifier 112 (i.e., the coding/care gap identifier computing device(s) 114). As such, the health plan computing device(s) 110 may include one or more endpoint computing devices (e.g., mobile computing devices, desktop computers, etc.) capable of interfacing with the coding/care gap identifier computing device(s) 114 via one or more access points, routers, switches, servers, compute devices, storage devices, etc., which may be in addition to those network computing devices of the network 106 as described herein.

The network 106 may be implemented as any type of wired and/or wireless network, such as a local area network (LAN), a wide area network (WAN), a global network (the Internet). Accordingly, the network 106 may include one or more communicatively coupled network computing devices (not shown) for facilitating the flow and/or processing of network communication traffic via a series of wired and/or wireless interconnects. Such network computing devices may include, but are not limited to, one or more access points, routers, switches, servers, compute devices, storage devices, etc. It should be appreciated that one or more of such network computing devices may be configured to couple to one or more of the computing devices 118 of the system 100 of FIG. 1 described herein using wired (e.g., Ethernet, token ring, etc.) and/or wireless (e.g., Bluetooth®, Wi-Fi®, wireless broadband, ZigBee®, etc.) communication technologies and associated protocols.

The coding/care gap identifier 112 may be implemented as any type of intermediary between the healthcare provider 102 and the health plan 108 that is capable of performing the functions described herein. To do so, the coding/care gap identifier 112 includes one or more computing devices 118 (i.e., the coding/care gap identifier computing devices 114) configured to communicate (i.e., exchange information) with the respective computing devices 118 of the healthcare provider 102 and the health plan 108. Accordingly, the coding/care gap identifier computing devices 114 may be embodied as any type of computing device(s) capable of performing the functions described herein, including, but not limited to, one or more servers, compute devices, storage devices, routers, switches, etc.

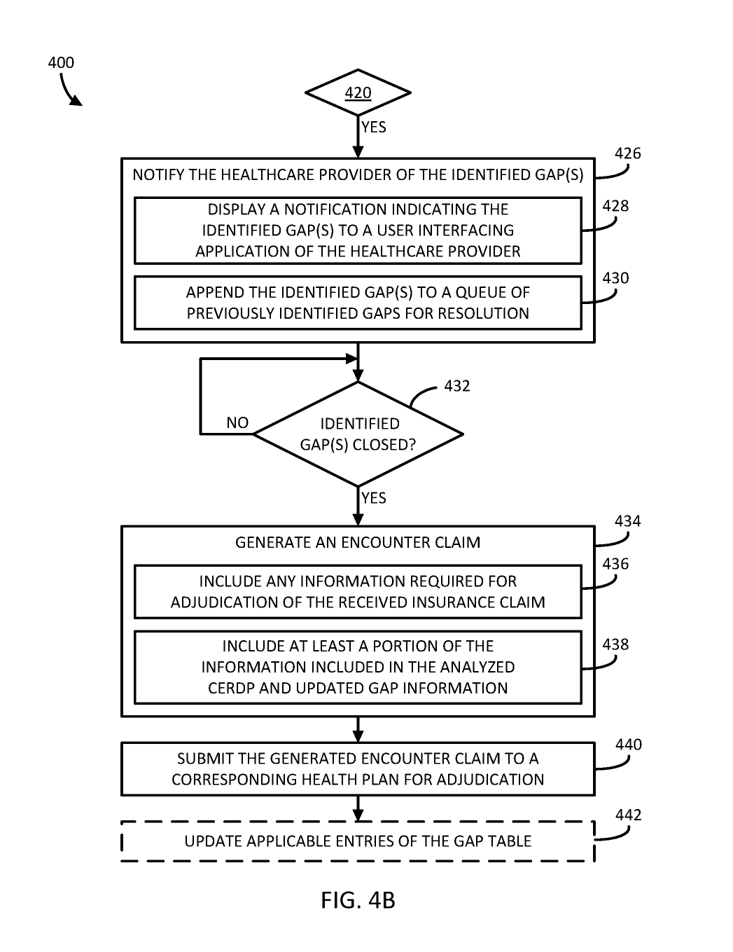

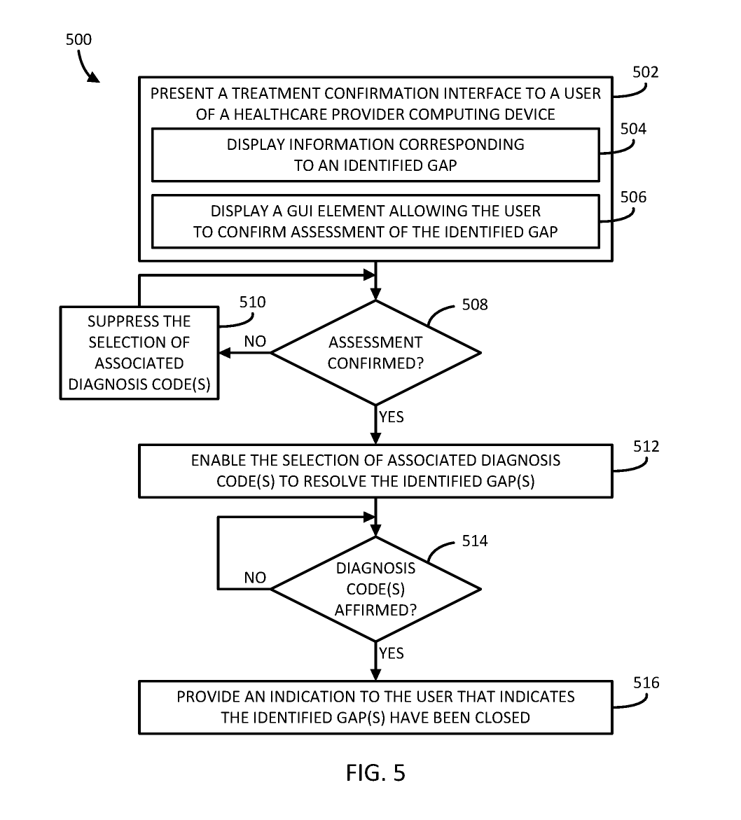

The illustrative coding/care gap identifier computing device 114 includes an coding/care gap analysis engine 116, which is described in further detail below. The coding/care gap analysis engine 116 may be embodied as any type of firmware, hardware, software, circuitry, or combination thereof capable of performing the functions described herein (see, in particular, FIGS. 4 and 5). It should be appreciated that the coding/care gap analysis engine 116 may reside on a single coding/care gap identifier computing device 114 or multiple coding/care gap identifier computing devices 114 (e.g., in a distributed architecture), depending on the configuration of the coding/care gap analysis engine 116 and the underlying system architecture.

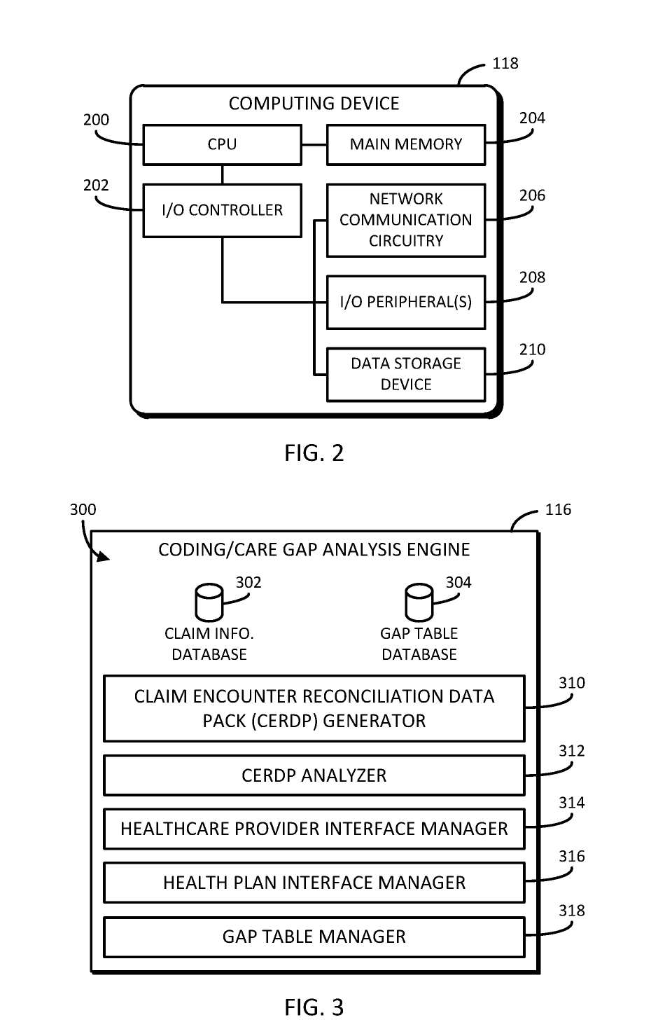

Referring now to FIG. 2, an illustrative embodiment of a computing device 118 representative of one or more of the healthcare provider computing devices 104, the health plan computing devices 110, and/or the coding/care gap identifier computing devices 114 is shown. As shown, the illustrative computing device 118 includes a central processing unit (CPU) 200, an input/output (I/O) controller 202, a memory 204, a network communication circuitry 206, one or more I/O peripherals 208, and a data storage device 210. It should be appreciated that alternative embodiments may include additional, fewer, and/or alternative components to those of the illustrative computing device 118, such as a graphics processing unit (GPU). It should be additionally appreciated that one or more of the illustrative components may be combined on a single system-on-a-chip (SoC) on a single integrated circuit (IC).

The CPU 200 may be embodied as any type of hardware or combination of circuitry capable of processing data. Accordingly, the CPU 200 may include one or more processing cores (not shown) in a single-core processor or a multi-core processor architecture capable of reading and executing program instructions. In some embodiments, the CPU 200 may include cache memory (not shown) that may be integrated directly with the CPU 200 or placed on a separate chip with a separate interconnect to the CPU 200. It should be appreciated that, in some embodiments, pipeline logic may be used to perform software and/or hardware operations (e.g., network communication operations), rather than commands issued to/from the CPU 200.

The I/O controller 202, or I/O interface, may be embodied as any type of computer hardware or combination of circuitry capable of interfacing between input/output devices and the computing device 118. Illustratively, the I/O controller 202 is configured to receive input/output requests from the CPU 200, and send control signals to the respective input/output devices, thereby managing the data flow to/from the computing device 118.

The memory 204 may be embodied as any type of computer hardware or combination of circuitry capable of holding data and instructions for processing. Such memory 204 may be referred to as main or primary memory. It should be appreciated that, in some embodiments, one or more components may have direct access to memory, such that certain data may be stored via direct memory access (DMA) independently of the CPU 200.

The network communication circuitry 206 may be embodied as any type of computer hardware or combination of circuitry capable of managing network interfacing communications (e.g., messages, datagrams, packets, etc.) via wireless and/or wired communication modes. Accordingly, in some embodiments, the network communication circuitry 206 may include a network interface controller (NIC) capable of being configured to connect the computing device 118 to a computer network (e.g., the network 106).

The one or more I/O peripherals 208 may be embodied as any auxiliary device configured to connect to and communicate with the computing device 118. For example, the I/O peripherals 208 may include, but are not limited to, a mouse, a keyboard, a monitor, a touchscreen, a printer, a scanner, a microphone, a speaker, etc. Accordingly, it should be appreciated that some I/O devices are capable of one function (i.e., input or output), or both (i.e., input and output).

In some embodiments, the I/O peripherals 208 may be connected to the computing device 118 via a cable (e.g., a ribbon cable, a wire, a universal serial bus (USB) cable, a high-definition multimedia interface (HDMI) cable, etc.) of the computing device 102. In such embodiments, the cable is connected to a corresponding port (not shown) of the computing device 102 for which the communications made therebetween are managed by the I/O controller 202. In alternative embodiments, the I/O peripherals 208 may be connected to the computing device 102 via a wireless mode of communication (e.g., Bluetooth®, Wi-Fi®, etc.) managed by the network communication circuitry 206.

The data storage device 210 may be embodied as any type of computer hardware capable of the non-volatile storage of data (e.g., semiconductor storage media, magnetic storage media, optical storage media, etc.). Such data storage devices 210 are commonly referred to as auxiliary or secondary storage, and are typically used to store a large amount of data relative to the memory 204 described above.

It should be appreciated that the type of components of the respective computing device 118 may be predicated upon the type and intended use of the respective computing device 118. In other words, the computing devices 118 of the healthcare provider 102 (i.e., the healthcare provider computing devices 104), the health plan 108 (i.e., the health plan computing devices 110), and/or the coding/care gap identifier 112 (i.e., the coding/care gap identifier computing devices 114) may be different types of computing devices 118.

For example, referring back to FIG. 1, the healthcare provider computing devices 104 and/or the health plan computing devices 110 may be architected in a client-server relationship with the coding/care gap identifier computing devices 114. In such an embodiment, the healthcare provider computing devices 104 and/or the health plan computing devices 110 may include a thick-client application (e.g., a dedicated interfacing application) or a thin-client application (e.g., a web browser) installed thereon that is in network communication with one or more of the coding/care gap identifier computing devices 114 (e.g., via a web server). In some embodiments, the configuration may be a cloud-based configuration, in which the operations performed by the coding/care gap identifier 112 are performed in the cloud and the data related thereto may be stored in the cloud as well.

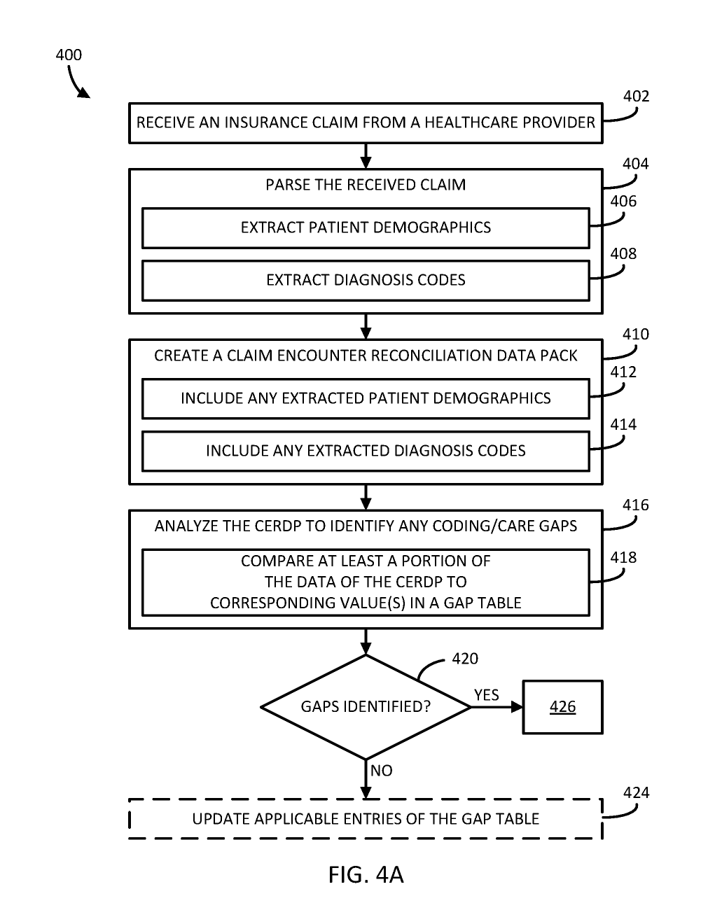

Referring now to FIG. 3, an illustrative environment 300 of the coding/care gap analysis engine 116 is shown. As described previously, the coding/care gap analysis engine 116 may be embodied as any type of firmware, hardware, software, circuitry, or combination thereof capable of performing the functions described herein. The illustrative environment 300 includes a claim information database 302 for storing insurance claim information received from the healthcare provider 102 (i.e., in the form of an insurance claim) and a gap table database 304 for storing gap table information (e.g., values of a health plan) usable to perform the coding/care gap analysis. While the claim information database 302 and the gap table database 304 are illustratively shown as residing on the coding/care gap identifier computing device 114 with the coding/care gap analysis engine 116, it should be appreciated that, in some embodiments, the claim information database 302 and/or the gap table database 304 may be located remote of the coding/care gap identifier computing device 114.

It should be appreciate that, in some embodiments, access to the data provided to and/or generated by the coding/care gap analysis engine 116 may require authorization and/or that such data be encrypted while in storage and/or transit. Accordingly, in some embodiments, one or more authentication and/or encryption technologies known to those of skill in the art may be employed by the coding/care gap analysis engine 116 to ensure the storage and access to the data complies with any legal and/or contractual requirements. It should be further appreciated that, in some embodiments, the data stored in the respective databases may not be mutually exclusive. In other words, certain data described herein as being stored in one database may additionally or alternatively be stored in another database described herein, or another database altogether. It should be further appreciated that, in some embodiments, the data may be stored in a single database, or an alternative database arrangement.

The illustrative environment 300 of the coding/care gap analysis engine 116 additionally includes a claim encounter reconciliation data pack (CERDP) record generator 310, a CERDP analyzer 312, a healthcare provider interface manager 314, a health plan interface manager 316, and a gap manager 318. In some embodiments, the CERDP generator 310, the CERDP analyzer 312, the healthcare provider interface manager 314, the health plan interface manager 316, and/or the gap manager 318 may include one or more computer-readable medium (e.g., the memory 204, the data storage device 210, and/or any other media storage device) having instructions stored thereon and one or more processors (e.g., the CPU 200) coupled with the one or more computer-readable medium and configured to execute instructions to perform the functions described herein.

The CERDP generator 310, which may be embodied as any type of firmware, hardware, software, circuitry, or combination thereof, is configured to generate a CERDP file (i.e., a digital file, or computer file) as a function of an insurance claim received from a healthcare provider 102. To do so, the CERDP generator 310 is configured to extract information (e.g., patient demographics, diagnosis codes, etc.) from the received insurance claim and include the extracted information into the CERDP file. Such information may be stored in the claim information database 302, in some embodiments.

The CERDP analyzer 312, which may be embodied as any type of firmware, hardware, software, circuitry, or combination thereof, is configured to analyze the CERDP to identify any gaps. For example, the CERDP analyzer 312 may be configured to compare at least a portion of the information contained in the CERDP file to one or more corresponding values in a gap table (i.e., values of a corresponding health plan) in order to identify a condition of interest. Such gap table information may be stored in the gap table database 304, in some embodiments. A condition of interest may be detected, for example, upon a determination that a diagnosis code present in the gap table is not accounted for in the current insurance claim. In an illustrative embodiment of the example, the CERDP analyzer 312 may determine the patient had been previously treated for diabetes, and the diagnosis code for diabetes is not present in the current insurance claim. In such an example, the CERDP analyzer 312 will flag the diagnosis code for diabetes as a coding/care gap. In still another example of a condition of interest, the CERDP analyzer 312 may determine that evidence of a standard of care for a claimed condition was not met. For example, The Healthcare Effectiveness Data and Information Set (HEDIS) is a tool used by more than 90 percent of America's health plans to measure performance on important dimensions of care and service. Altogether, HEDIS consists of 81 measures across 5 domains of care. The presently disclosed systems and methods can be used to identify and close care gaps.

The healthcare provider interface manager 314, which may be embodied as any type of firmware, hardware, software, circuitry, or combination thereof, is configured to manage interfacing with the healthcare provider 102 (i.e., one of the healthcare provider computing devices 104) from which the insurance claim was received. To do so, the healthcare provider interface manager 314 is configured to facilitate the notification of any identified gaps, such as may be identified by the CERDP analyzer 312, to the healthcare provider 102. For example, in some embodiments, the healthcare provider interface manager 314 may be configured to transmit a notification (e.g., a visual indication) to an interface of a web-based application. Additionally or alternatively, in some embodiments, the healthcare provider interface manager 314 may be configured to present a listing of all of the identified gaps to the healthcare provider 102, such as in a queue of identified coding/care gaps for review.

The healthcare provider interface manager 314 is additionally configured to facilitate the closing of those gaps identified and presented to the healthcare provider 102, such that a user of the healthcare provider computing device 104 being used to view the identified gaps can also resolve the identified gaps. For example, in some embodiments, the healthcare provider interface manager 314 may display information corresponding to the identified gap and a manner by which to submit additional information to resolve the identified gap (e.g., confirm an assessment, enter a missing diagnosis code, confirm a previously entered diagnosis code, select an alternative diagnosis code, etc.), such as by using graphical user interface (GUI) elements displayed via a user interface of a corresponding application.

The health plan interface manager 316, which may be embodied as any type of firmware, hardware, software, circuitry, or combination thereof, is configured to manage interfacing with the health plan 108 (i.e., one of the health plan computing devices 110) for which the insurance claim corresponds. For example, the health plan interface manager 316 is configured to submit an encounter insurance claim (related to the previously submitted insurance claim) to the appropriate health plan 108 for adjudication.

However, if any gaps were identified and subsequently resolved (e.g., by the healthcare provider 102 via the healthcare provider interface manager 314), the health plan interface manager 316 is configured to generate a related encounter insurance claim that includes at least a portion of the originally received insurance claim and any relevant portions of the CERDP, as well as any additional information received as a result of the gap resolution. In some embodiments, the health plan interface manager 316 may be configured to include any additional information required for adjudication with the related encounter insurance claim. Additionally, the health plan interface manager 316 is configured to transmit the related insurance claim to the health plan 108.

The gap manager 318, which may be embodied as any type of firmware, hardware, software, circuitry, or combination thereof, is configured to manage the gap table (e.g., as may be stored in the gap table database 304). To do so, the gap manager 318 is configured to access, add, remove, and modify the gap table. For example, the coding/care gap analysis engine 116 may receive a file containing coding/care gaps, targeted members, and/or health care provider to member attribution information. Accordingly, the gap manager 318 is additionally configured to parse the pertinent information from the health plan file and update the gap table as necessary.

Referring now to FIGS. 4A and 4B, an illustrative method 400 is provided for coding/care gap identification that may be performed by an coding/care gap analysis engine (e.g., the coding/care gap analysis engine 116 of FIG. 3). The method begins in block 402, in which the coding/care gap analysis engine 116 receives an insurance claim from a healthcare provider (e.g., the healthcare provider 102 of FIG. 1 via one or more of the healthcare provider computing devices 104) for a patient who is a member of or subscriber to an insurance policy provided by a health plan (e.g., the health plan 108 of FIG. 1). It should be appreciated that the insurance claim may be received from the healthcare provider 102 through a transmission mode, such as, but not limited to batch, business-to-business, a system portal, or the like.

In block 404, the coding/care gap analysis engine 116 processes the received claim. To do so, in block 406, the coding/care gap analysis engine 116 extracts any patient demographic information from the received claim. Additionally, in block 408, the coding/care gap analysis engine 116 extracts any diagnosis codes (e.g., International Classification of Diseases, Ninth (ICD-9) diagnosis codes, ICD-10 diagnosis codes, etc.) from the received claim. It should be appreciated that, in some embodiments, the coding/care gap analysis engine 116 may extract additional and/or alternative information.

In block 410, the coding/care gap analysis engine 116 creates a claim encounter reconciliation data pack (CERDP). To do so, the coding/care gap analysis engine 116 includes any extracted patient demographics in block 412 and any extracted diagnosis codes in block 414. It should be appreciated that additional and/or alternative information may be included in the CERDP as necessary to perform the functions as described herein. In block 416, the coding/care gap analysis engine 116 analyzes the CERDP file to identify any gaps. To do so, in block 418, the coding/care gap analysis engine 116 may be configured to compare at least a portion of the data of the CERDP to one or more corresponding values in a gap table. In an illustrative embodiment, the gap table may include historical data related to the patient demographics and diagnosis codes from previous insurance claims, either of which may be used for the analysis. It should be appreciated that, in some embodiments, additional and/or alternative comparisons and/or analyses may be performed on the CERDP to identify any coding/care gaps.

In block 420, the coding/care gap analysis engine 116 determines whether any insurance gaps have been identified. If so, the method 400 branches to block 426 which is described below and shown in FIG. 4B; otherwise, if the coding/care gap analysis engine 116 determines that no gaps have been identified, the method 400 advances, in some embodiments, to block 424, where the coding/care gap analysis engine 116 is additionally configured to update any applicable entries of the gap table (e.g., for historical medical data purposes) based on the received/submitted claim. In some embodiments, the gap table may be updated periodically, for example daily, weekly, biweekly, monthly, etc. with information from the health plan and may include a file containing coding/care gaps, targeted members, and/or health care provider to member attribution information.

As described previously, if the coding/care gap analysis engine 116 determines that any coding/care gaps have been identified in block 420, the method branches to block 426 of FIG. 4B. In block 426, the coding/care gap analysis engine 116 notifies the healthcare provider (i.e., from which the original insurance claim was received) of the gap(s) identified in block 416 (i.e., as a result of the analysis performed therein). To do so, in block 428, the coding/care gap analysis engine 116 displays a notification indicating the detection of the identified gap(s) to a user interfacing application (e.g., a thin-client application, a thick-client application, etc.) of the healthcare provider. Additionally, in block 430, the coding/care gap analysis engine 116 appends the identified gap(s) to a queue of previously identified gaps for resolution by the user (e.g., at a later point in time).

In block 432, the coding/care gap analysis engine 116 determines whether the identified gap(s) were closed, or otherwise resolved (see, e.g., the method 500 of FIG. 5 for an illustrative embodiment of resolving identified gaps). If so, the method 400 advances to block 434 in which the coding/care gap analysis engine 116 generates a new insurance claim (i.e., an encounter claim) that is indicative of being related to the original insurance claim initially received from the healthcare provider. To do so, in block 436, the coding/care gap analysis engine 116 includes any information required for adjudication of the received insurance claim. Additionally, in block 438, the coding/care gap analysis engine 116 includes at least a portion of the information included in the analyzed CERDP (e.g., information including and/or in addition to that of the originally received insurance claim used to generate the CERDP for analysis), as well as any updated information received as a result of resolving, or closing, the identified coding/care gaps.

In block 440, the coding/care gap analysis engine 116 is configured to submit the encounter claim generated in block 434 to a corresponding health plan (i.e., based on the insurance plan of the patient to which the insurance/encounter claim corresponds). Additionally, in some embodiments, in block 442, the coding/care gap analysis engine 116 may be further configured to update any applicable entries of the gap table (e.g., for historical medical data purposes) based on the received insurance claim and/or the generated encounter claim.

Referring now to FIG. 5, an illustrative method 500 is provided for resolving identified insurance gaps that may be performed by an coding/care gap analysis engine (e.g., the coding/care gap analysis engine 116 of FIG. 3). As described previously, a healthcare provider (e.g., an authorized user thereof) may be presented with a list of previously identified coding/care gaps that are in need of resolution, or closing of the coding/care gaps.

The method begins in block 502, in which the coding/care gap analysis engine 116 presents an assessment confirmation interface to a user of a healthcare provider computing devices 104 that is configured to and authorized to access the assessment confirmation interface. To do so, in block 504, the coding/care gap analysis engine 116 displays information corresponding to the identified gap. Additionally, in block 506, the coding/care gap analysis engine 116 displays a GUI element that allows the user to confirm the patient was assessed for the condition associated with the identified gap and it was confirmed whether the patient had the condition.

In block 508, the coding/care gap analysis engine 116 determines whether an assessment of the patient condition was rendered. In other words, the coding/care gap analysis engine 116 determines whether the user has acknowledged that an assessment was rendered on the particular date of service for the condition of interest being questioned. In an illustrative embodiment, a coding/care gap interface may be displayed that includes the patient's demographics, the diagnosis codes that were submitted on the original claim, a list of the open coding/care gaps, and/or the diagnosis code and description associated with each coding/care gap. In such an embodiment, the interface may include a “yes” or “no” GUI control element for each coding/care gap that is accessible to the user such that the user can identify whether the patient was assessed for the open coding/care gap (“yes”) or whether the patient was not assessed for the open coding/care gap (“no”).

Should the user indicate that the patient was not assessed for one or more, but not all, of the open gaps (i.e., the user indicated “no”), the diagnosis code(s) related thereto can be excluded from the encounter claim that is generated once the coding/care gap form is completed (see, e.g., the description of block 434 of the method 400 of FIG. 4). In some embodiments, should the user indicate that the patient was not assessed for any of the gaps identified, the encounter claim will not be generated and the attributed coding/care gaps will remain unclosed and eligible in the future (e.g., for when a new coding/care gap form for the patient is submitted for payment/adjudication). Alternatively, should the user indicate that one or more of the open gaps were assessed (i.e., the user indicated “yes” and, if the assessment indicated that the patient has the condition, submits the diagnosis code(s) related thereto), the encounter claim will be generated for that patient and sent to the corresponding health plan for consumption and processing within the insurance carrier's claim adjudication system.

It should be appreciated that, in all cases, the healthcare provider submits the diagnosis codes on the original claim for payment. However, the diagnosis code(s) listed in the gap table could contain both ICD-9 and newer ICD-10 coding/care gaps. In a situation where there is a ICD-9 coding gap listed in the gap table, the form will present the ICD-9 coding/care diagnosis code and description listed in the gap table, however, the coding/care gap form will also list the corresponding ICD-10 diagnosis code(s) that will close the ICD-9 coding gap. In one embodiment, the Centers for Medicare & Medicaid Services General Equivalence Mapping “CMS GEM” standard is used to map the codes. The CMS GEM standard enables conversion of data from ICD-9 to ICD-10 and vice versa. The CMS GEM standard provides information linking codes of one system with codes in another system. In one embodiment, there may be more than one ICD-10 that the user will have to select, in order to close a single ICD-9 coding/care gap. Accordingly, the generated new claim will only include ICD-10 diagnosis codes when submitted to the payer gateway for processing within the insurance carrier's claim adjudication system.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method for coding/care gap identification, the method comprising:
receiving, by a computing device, an insurance claim from a healthcare provider;
creating, by the computing device, a claim encounter reconciliation data pack (CERDP) based on the received insurance claim;
analyzing, by the computing device, the CERDP to identify whether any coding/care gaps exist in the received insurance claim;
providing, by the computing device and in response to having determined one or more coding/care gaps as a function of the analysis of the CERDP, the healthcare provider with an interface to view and resolve the identified coding/care gaps;
receiving, by the computing device via the interface, related claim information as a function of the resolution of the identified coding/care gaps;
generating, by the computing device and in response to a determination that the identified coding/care gaps have been resolved, an encounter claim, wherein the encounter claim includes the related claim information and at least a portion of the information of the CERDP; and
transmitting, by the computing device, the generated encounter claim to a corresponding health plan.

2. The method of claim 1, wherein analyzing the CERDP comprises comparing the claim information of the CERDP to corresponding patient information of a gap table, wherein the corresponding patient information of the gap table includes patient demographic information, historical claim information, historical treatment information, previously submitted diagnosis codes, and health plan information.

3. The method of claim 1, wherein creating the CERDP comprises (i) processing the received claim, (ii) extracting data from the received claim as a function of the processing of the received claim, (iii) generating the CERDP, and (iv) incorporating the extracted data into the generated CERDP.

4. The method of claim 3, wherein extracting data from the received claim comprises extracting at least one of patient demographic information, treatment information, and one or more diagnosis codes.

5. The method of claim 1, further comprising submitting, by the computing device, the received insurance claim to a corresponding health plan, wherein the insurance claim is usable to adjudicate the insurance claim.

6. The method of claim 1, further comprising updating, by the computing device and in response to having received the updated claim information as a function of the resolution of the identified coding/care gaps, the gap table based on the updated claim information.

7. The method of claim 1, further comprising providing, by the computing device and in response to having determined the one or more coding/care gaps, the healthcare provider with an indication of the identified coding/care gaps via a notification viewable in the provided interface.

8. A computing device for coding/care gap identification, the computing device comprising:
one or more computer-readable medium comprising instructions;
one or more processors coupled with the one or more computer-readable medium and configured to execute the instructions to:
receive an insurance claim from a healthcare provider;
create a claim encounter reconciliation data pack (CERDP) based on the received insurance claim;
analyze the CERDP to identify whether any coding/care gaps exist in the received insurance claim;
provide, in response to having determined one or more coding/care gaps as a function of the analysis of the CERDP, the healthcare provider with an interface to view and resolve the identified coding/care gaps;
receive, via the interface, related claim information as a function of the resolution of the identified coding/care gaps;
generate, in response to a determination that the identified coding/care gaps have been resolved, an encounter claim, wherein the encounter claim includes the related claim information and at least a portion of the information of the CERDP; and
transmit the generated encounter claim to a corresponding health plan.

9. The computing device of claim 8, wherein to analyze the CERDP comprises to compare the claim information of the CERDP to corresponding patient information of a gap table, wherein the corresponding patient information of the gap table includes patient demographic information, historical claim information, historical treatment information, previously submitted diagnosis codes, and health plan information.

10. The computing device of claim 8, wherein to create the CERDP comprises to (i) process the received claim, (ii) extract data from the received claim as a function of the processing of the received claim, (iii) generate the CERDP, and (iv) incorporating the extracted data into the generated CERDP.

11. The computing device of claim 10, wherein to extract data from the received claim comprises to extract at least one of patient demographic information, treatment information, and one or more diagnosis codes.

12. The computing device of claim 8, wherein the one or more computer-readable medium are further configured to execute the instructions to submit the received insurance claim to a corresponding health plan, wherein the insurance claim is usable to adjudicate the insurance claim.

13. The computing device of claim 8, wherein the one or more computer-readable medium are further configured to execute the instructions to update, in response to having received the updated claim information as a function of the resolution of the identified coding/care gaps, the gap table based on the updated claim information.

14. The computing device of claim 8, wherein the one or more computer-readable medium are further configured to execute the instructions to provide, in response to having determined the one or more coding/care gaps, the healthcare provider with an indication of the identified coding/care gaps via a notification viewable in the provided interface.

15. A non-transitory computer-readable medium storing executable instructions on a computing device, the executable instructions that cause the computing device to perform the steps of:
receive an insurance claim from a healthcare provider;
create a claim encounter reconciliation data pack (CERDP) based on the received insurance claim;
analyze the CERDP to identify whether any coding/care gaps exist in the received insurance claim;
provide, in response to having determined one or more coding/care gaps as a function of the analysis of the CERDP, the healthcare provider with an interface to view and resolve the identified coding/care gaps;
receive, via the interface, related claim information as a function of the resolution of the identified coding/care gaps;
generate, in response to a determination that the identified coding/care gaps have been resolved, an encounter claim, wherein the encounter claim includes the related claim information and at least a portion of the information of the CERDP; and
transmit the generated encounter claim to a corresponding health plan.

16. The non-transitory computer-readable medium of claim 15, wherein to analyze the CERDP comprises to compare the claim information of the CERDP to corresponding patient information of a gap table, wherein the corresponding patient information of the gap table includes patient demographic information, historical claim information, historical treatment information, previously submitted diagnosis codes, and health plan information.

17. The non-transitory computer-readable medium of claim 15, wherein to create the CERDP comprises to (i) process the received claim, (ii) extract data from the received claim as a function of the processing of the received claim, (iii) generate the CERDP, and (iv) incorporating the extracted data into the generated CERDP.

18. The non-transitory computer-readable medium of claim 17, wherein to extract data from the received claim comprises to extract at least one of patient demographic information, treatment information, and one or more diagnosis codes.

19. The non-transitory computer-readable medium of claim 15, wherein the executable instructions further cause the computing device to execute the instructions to submit the received insurance claim to a corresponding health plan, wherein the insurance claim is usable to adjudicate the insurance claim.

20. The non-transitory computer-readable medium of claim 15, wherein the executable instructions further cause the computing device to execute the instructions to update, in response to having received the updated claim information as a function of the resolution of the identified coding/care gaps, the gap table based on the updated claim information.

21. The non-transitory computer-readable medium of claim 15, wherein the executable instructions further cause the computing device to execute the instructions to provide, in response to having determined the one or more coding/care gaps, the healthcare provider with an indication of the identified coding/care gaps via a notification viewable in the provided interface.
